(19) United States
(12) Patent Application Publication
(10) Pub. No.: US 2023/0325708 A1
(43) Pub. Date: Oct. 12, 2023

(54) PAIRWISE FEATURE ATTRIBUTION FOR INTERPRETABLE INFORMATION RETRIEVAL

(71) Applicant: SAP SE, Walldorf (DE)

(72) Inventors: Stefan Klaus Baur, Heidelberg (DE); Matthias Frank, Heidelberg (DE); Hoang-Vu Nguyen, Leimen (DE); Kannan Presanna Kumar, Berlin (DE)

(21) Appl. No.: 17/718,850

(22) Filed: Apr. 12, 2022

(51) Int. Cl. G06N 20/00; G06V 10/74; G06V 10/766

(52) U.S. Cl. CPC G06N 20/00; G06V 10/761; G06V 10/766

(57) ABSTRACT

Computer-readable media, methods, and systems are disclosed for feature attribution in a machine learning model. Samples may be generated for a machine learning model based on a normalized probability distribution. The samples may be used to determine a weight for features and feature pairs for the machine learning model. The weights of the features and feature pairs may be used to determine which features are significant for predictions within the machine learning model.

### TECHNICAL FIELD

Embodiments generally relate to providing an explanation for machine learning algorithms, and more particularly to providing a pairwise feature attribution for information retrieval machine learning algorithms.

Governments and businesses are relying more and more on predictions from artificial intelligence models and machine learning algorithms. Many of these machine learning algorithms are a black box, making it difficult to determine which variables are most responsible for the predictions. To enhance end-user trust and help in the analysis of possible prediction errors, these predictions need to be accompanied by additional information which at least partially explains why a machine learning algorithm makes a certain prediction.

One important class of machine learning problems is the area of information retrieval. Information retrieval problems include semantic search, image retrieval and entity matching. Information retrieval problems often have specific interactions between features which may impact predictions. These feature pairs can impact predictions more than either feature on its own. This issue is also present in classification problems with strong feature interactions, such as where the feature set splits into two distinct groups, such as multi-modal classification of image and text.

Accordingly, what is needed are methods, systems, and media for providing an explanation of which features are significant for information retrieval machine learning algorithms involving interactions between features.

### SUMMARY

Disclosed embodiments of the present technology solve the above-mentioned problems by providing systems, methods, and computer-readable media for determining which features and feature pairs are significant for machine learning algorithms. By examining the interactions between pairs of features, additional explanations may be provided which would not be knowable by examining individual features alone. Such explanations are particularly useful for explaining information retrieval algorithms, where the interactions between features may be especially important. These solutions are also model agnostic, allowing the solutions to be used for any machine learning model type and do not require any feature pruning to be efficient. Further, an improved sampling scheme increases computational efficiency by sampling based on a normalized probability distribution to determine the feature weights using fewer samples to improve runtime.

In some aspects, the techniques described herein relate to one or more non-transitory computer-readable media storing computer-executable instructions that, when executed by at least one processor, perform a method for feature attribution in a machine learning model, the method including: receiving, from a user, a machine learning model and input data; generating a prediction using the machine learning model and the input data; generating a plurality of samples for the machine learning model by eliminating features from the input data and the prediction; calculating a weight for at least one feature and at least one feature pair of the input data and the prediction using the plurality of samples; and transmitting the weight for the at least one feature and the at least one feature pair to the user.

In some aspects, the techniques described herein relate to a non-transitory computer-readable media, wherein the machine learning model is an information retrieval machine learning model.

In some aspects, the techniques described herein relate to a non-transitory computer-readable media, wherein the plurality of samples for the machine learning model are generated based on a normalized probability distribution.

In some aspects, the techniques described herein relate to a non-transitory computer-readable media, wherein calculating the weight for one or more features and one or more feature pairs involves a local interpretable model-agnostic explanation method.

In some aspects, the techniques described herein relate to a non-transitory computer-readable media, wherein generating a plurality of samples for the machine learning model uses a Hamming distance to determine the plurality of samples.

In some aspects, the techniques described herein relate to a non-transitory computer-readable media, wherein the input data is an image, and the plurality of samples are generated by graying out regions of superpixels from the image.

In some aspects, the techniques described herein relate to a non-transitory computer-readable media, wherein calculating the weight for the at least one feature and the at least one feature pair is done using a ridge regression.

In some aspects, the techniques described herein relate to a method for method for feature attribution in a machine learning model, the method including: receiving, from a user, a machine learning model and input data; generating a prediction using the machine learning model and the input data; generating a plurality of samples for the machine learning model by eliminating features from the input data and the prediction; calculating a weight for at least one feature and at least one feature pair of the input data and the prediction using the plurality of samples; and transmitting the weight for the at least one feature and the at least one feature pair to the user.

In some aspects, the techniques described herein relate to a method, wherein the machine learning model is an information retrieval machine learning model.

In some aspects, the techniques described herein relate to a method, wherein the plurality of samples for the machine learning model are generated based on a normalized probability distribution.

In some aspects, the techniques described herein relate to a method, wherein calculating the weight for one or more features and one or more feature pairs involves a local interpretable model-agnostic explanation method.

In some aspects, the techniques described herein relate to a method, wherein generating a plurality of samples for the machine learning model uses a Hamming distance to determine the plurality of samples.

In some aspects, the techniques described herein relate to a method, wherein the input data is an image, and the plurality of samples are generated by graying out regions of superpixels from the image.

In some aspects, the techniques described herein relate to a method, wherein calculating the weight for the at least one feature and the at least one feature pair is done using a ridge regression.

In some aspects, the techniques described herein relate to a system for feature attribution in a machine learning model, the system including: at least one processor; and at least one non-transitory memory storing computer executable instructions that when executed by the at least one processor cause the system to carry out actions including: receiving, from a user, a machine learning model and input data; generating a prediction using the machine learning model and the input data; generating a plurality of samples for the machine learning model by eliminating features from the input data and the prediction; calculating a weight for at least one feature and at least one feature pair of the input data and the prediction using the plurality of samples; and transmitting the weight for the at least one feature and the at least one feature pair to the user.

In some aspects, the techniques described herein relate to a system, wherein the machine learning model is an information retrieval machine learning model.

In some aspects, the techniques described herein relate to a system, wherein the plurality of samples for the machine learning model are generated based on a normalized probability distribution.

In some aspects, the techniques described herein relate to a system, wherein calculating the weight for one or more features and one or more feature pairs involves a local interpretable model-agnostic explanation method.

In some aspects, the techniques described herein relate to a system, wherein generating a plurality of samples for the machine learning model uses a Hamming distance to determine the plurality of samples.

In some aspects, the techniques described herein relate to a system, wherein the input data is an image, and the plurality of samples are generated by graying out regions of superpixels from the image.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present teachings will be apparent from the following detailed description of the embodiments and the accompanying drawing figures.

### BRIEF DESCRIPTION OF THE DRAWING FIGURES

Embodiments are described in detail below with reference to the attached drawing figures, wherein:

FIG. 1 illustrates an exemplary use case for some embodiments;

FIG. 2 illustrates an exemplary use case for some embodiments;

FIG. 3 illustrates an exemplary machine learning model system;

FIG. 4 illustrates an exemplary system for an embodiment;

FIG. 5 illustrates an exemplary flow diagram illustrating a method of an embodiment; and

FIG. 6 illustrates a diagram of an exemplary computing device architecture for implementing various aspects described herein.

The drawing figures do not limit the present teachings to the specific embodiments disclosed and described herein. The drawings are not necessarily to scale, emphasis instead being placed upon clearly illustrating the principles of the disclosure.

### DETAILED DESCRIPTION

The following detailed description of embodiments references the accompanying drawings that illustrate specific embodiments in which the present teachings can be practiced. The described embodiments are intended to illustrate aspects of the present teachings in sufficient detail to enable those skilled in the art to practice the present teachings. Other embodiments can be utilized, and changes can be made without departing from the claims. The following detailed description is, therefore, not to be taken in a limiting sense. The scope of embodiments is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate reference to “one embodiment” “an embodiment”, or “embodiments” in this description do not necessarily refer to the same embodiment and are also not mutually exclusive unless so stated and/or except as will be readily apparent to those skilled in the art from the description. For example, a feature, structure, or act described in one embodiment may also be included in other embodiments but is not necessarily included. Thus, the technology can include a variety of combinations and/or integrations of the embodiments described herein.

Embodiments are contemplated which permit a user to determine which features, and which pairwise features, of a machine learning model are significant. Machine learning models are often black boxes which limits a user's ability to understand how the model actually works. By allowing a user to understand which features are significant, a user can have a better understanding of the underlying model to ensure the model is functioning properly. In some embodiments, an existing machine learning model may be supplied. The machine learning model may be an information retrieval machine learning model, or any other type of machine learning model. Samples may be generated for the machine learning model which can allow the weights of the features, as well as the weights of feature pairs, to be determined. In some embodiments, the samples may be generated using a normalized probability distribution. Using the samples, a weight is determined for every feature and every feature pair. The weight for each feature and feature pair is a measure of how significant that feature is for the model's predictions. A feature or feature pair with a higher weight means that the feature is more important in the model's prediction, whereas a lower weight indicates that the feature or feature pair is less significant. The weights of the features can be used to ensure both that the machine learning model is functioning properly and permit troubleshooting of any issues. Problems with the training set may be detected if features which should not be significant have a large weight. For example, a user may intend for a machine learning model to classify pictures of animals based on what the animal in the image looks like. However, a data set with pictures of dogs on grass and cats on snow may lead a machine learning model to classify an animal based on whether or not the background of a picture is grass or snow, not what the animal looks like. By showing that the background of images in such a classification algorithm has a high weight, the issue with the training data may be addressed. As another example, the weights of a machine learning model can help determine if a machine learning model is improperly relying on some features of a data set, such as gender, which may be contrary to laws in certain regions.

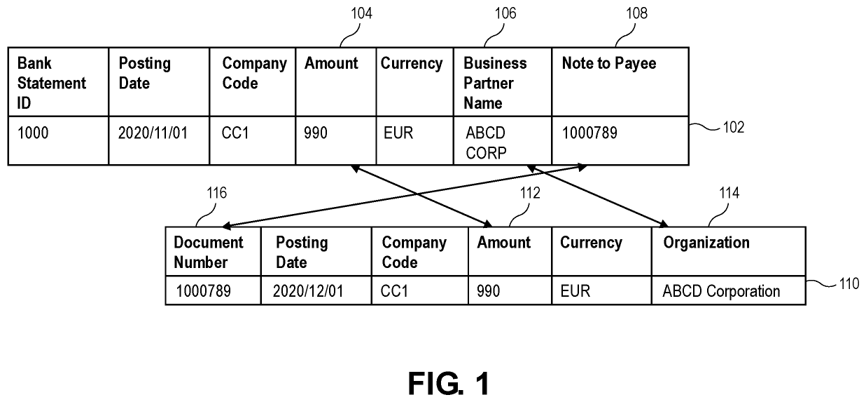

FIG. 1 depicts an exemplary use case for some embodiments. In some embodiments, a machine learning model may be trained to find a document which corresponds to an input document. In some embodiments, the documents may be financial documents, such as bank statements, invoices, accounts receivable entries, checks, or any document comprising financial information. In further embodiments, any type of text-based matching machine learning model may be used. Matching documents may allow users to efficiently handle accounting and financial tasks by determining the flow of financial resources. For example, a machine learning model may wish to find an accounts receivable entry that corresponds to a particular bank statement showing that a purchase was made.

Bank statement 102 is depicted along with invoice 110. Bank statement 102 may comprise columns for amount 104, business partner name 106, and note to payee 108, among other columns. Invoice 110 may comprise columns for amount 112, organization 114, and document number 116, among other columns. Columns from bank statement 102 may correspond to columns from invoice 110, indicating that bank statement 102 corresponds to invoice 110. In some embodiments, columns may match when both the column name and value are the same. For example, both amount 104 and amount 112 have the same name, amount, and value, 990. In further embodiments, columns may match when at least the value is the same. For example, both note to payee 108 and document number 116 have the same value, 1000789. In some embodiments, the value from a first column may be present in a matching column within other text, such as if note to payee 108 included additional notes in addition to 1000789. In still further embodiments, columns may match when there is a fuzzy or incomplete match, or the value between the columns is similar enough. For example, business partner name 106 has a value of ABCD CORP which may be a fuzzy match to organization 114 which has a value of ABCD Corporation. A machine learning model may determine that amount 104, business partner name 106, and note to payee 108 were significant in determining that bank statement 102 corresponds to invoice 110. However, a user would prefer to know, for example, that the pair of amount 104 and amount 112 are significant. It is the interaction between the features of bank statement 102 and invoice 110 which are actually determinative of the match. Disclosed embodiments capture this information by determining the weight of pairwise functions.

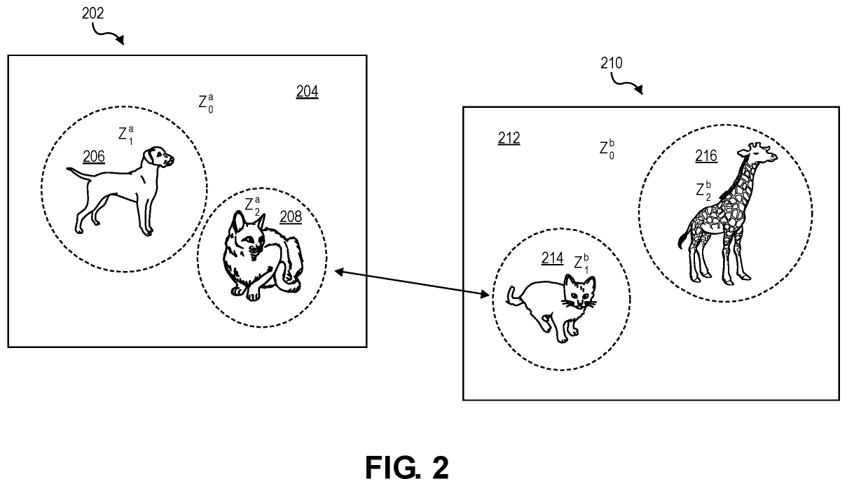

FIG. 2 depicts another exemplary use case for some embodiments. Similar to the text-based matching described in FIG. 1, image matching may also benefit from disclosed embodiments. Image 202 is depicted as entity “a” comprising background 204, animal 206, and animal 208. Image 210 is depicted as entity “b” comprising background 212, animal 214, and animal 216. In some embodiments, image 202 may be input from a user who wishes to find an image that contains a matching animal species which would be considered a matching image. For example, a first image containing a cat would match a second image also containing a cat. In some embodiments, regions within an image may be grouped together as superpixels in a preprocessing step. Superpixels may be segments of an image that correspond to the same thing, such as an object. Various clustering methods or segmentation algorithms, including machine learning methods, may be used to segment images as superpixels. Image 202 and image 210 each depict images containing two objects grouped together as superpixels, animal 206 and animal 208, and animal 214 and animal 216 respectively. In some embodiments, the remaining pixels may be grouped together as a background, as depicted as background 204 and background 212. An effective machine learning model would detect that animal 208 matches animal 214, and therefore image 202 is a match to image 210. It would be useful to a user analyzing the machine learning model to know that image 210 was selected as a match to image 202 because of a high weight of animal 208 and animal 214 together, not just that animal 208 and animal 214 individually were significant. Disclosed embodiments provide this advantage.

As one example of a specific scenario of how the representation of relevant features and interactions could work in an embedding model, an embedding for image 202 (entity a) could result in an embedding vector that may be linearly decomposed as:

\vec{g}ₐ=z_{z}^{a}\vec{g}_{Dog}+z₂^{a} \vec{g}_{Cat}.

Likewise, image 210 (entity b) would result in an embedding vector that may be linearly decomposed as

\vec{g}_{b}=z_{z}^{b}\vec{g}_{Cat}+z₂^{b} \vec{g}_{Giraffe}.

In other words, in this example, the pairwise interactions are significant while the individual features do not contribute. In both instances, it may be assumed that the background is mapped to the zero vector as it is irrelevant for the current task of finding an image containing a matching animal. Assuming that the embedding vectors for individual animals are roughly orthogonal, the mixed product terms containing, for example, \vec{g}_{Dog}\vec{g}_{Cat} are approximately zero. The score function for the inner product of the embedding would therefore be

f(\vec{a}, \vec{b})=\vec{g}(\vec{a})·\vec{g}(\vec{b})≈z₂^{a}z₁^{b}\vec{g}_{Cat}·\vec{g}_{Cat}.

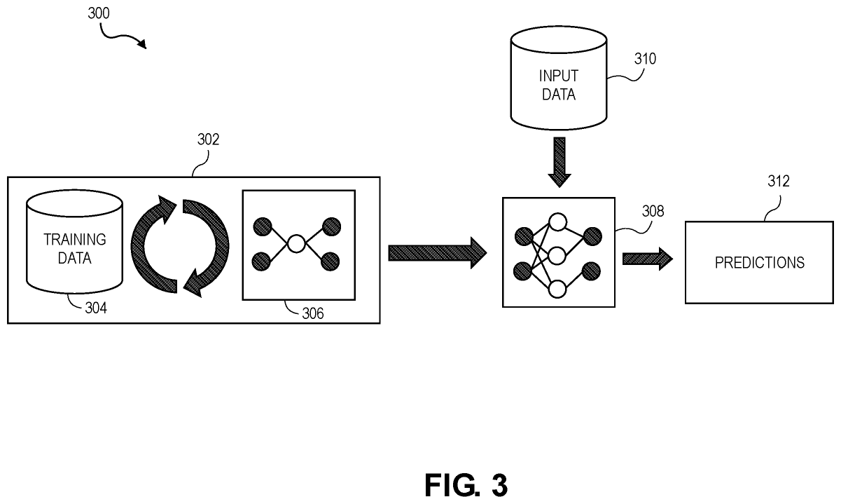

FIG. 3 depicts an exemplary machine learning model system 300. Machine learning can be used in a variety of industries to solve problems such as clustering, classification, regression, anomaly detection, association, and information retrieval. In some embodiments, machine learning may utilize a neural network. In further embodiments, machine learning models take in one or more inputs and produce an output, which is often a prediction based on the one or more inputs. For example, some classification machine learning models take in images as inputs and predict what the image depicts, such as specific species of animals. The output may be the name of an animal that the model predicts is depicted in the image, such as a dog, a cat, or a giraffe.

Machine learning model system may comprise training process 302. In some embodiments, training process 302 comprises training data 304 and initial model 306. Training data 304 may be labeled or unlabeled depending on the specific machine learning application. In some embodiments, training data 304 may exist in multiple different locations. Initial model 306 may be any initial machine learning model which is to be trained using training data 304. In some embodiments, training initial model 306 involves iteratively training initial model 306 using training data 304. In some embodiments, a portion of training data may be reserved to evaluate the accuracy of intermediate versions of initial model 306. Training data 304 may be selected depending on the type of initial model 306. In some embodiments, training process 302 may involve multiple machine learning models training in an adversarial environment. Training process 302 may be used to train any type of machine learning model, including models training with supervised learning, unsupervised learning, or reinforcement learning. In some embodiments, a portion of training data 304 may be reserved until the end of training process 302 to provide data for testing the initial model 306 throughout or after training.

In some embodiments, training process 302 results in trained machine learning model 308. Input data 310 can be input into trained machine learning model 308 to produce predictions 312. For example, trained machine learning model 308 may receive as input data 310 an input image and an image database, and be required to find an image in the image database which corresponds to the input image. For example, given input data 310, machine learning 308 may produce a numeric score for each image in the image database, and select as the prediction the image with the highest score. In some embodiments, trained machine learning model 308 may continue to be trained and refined even after training process 302. Predictions 312 may be stored in a database or transmitted to a user.

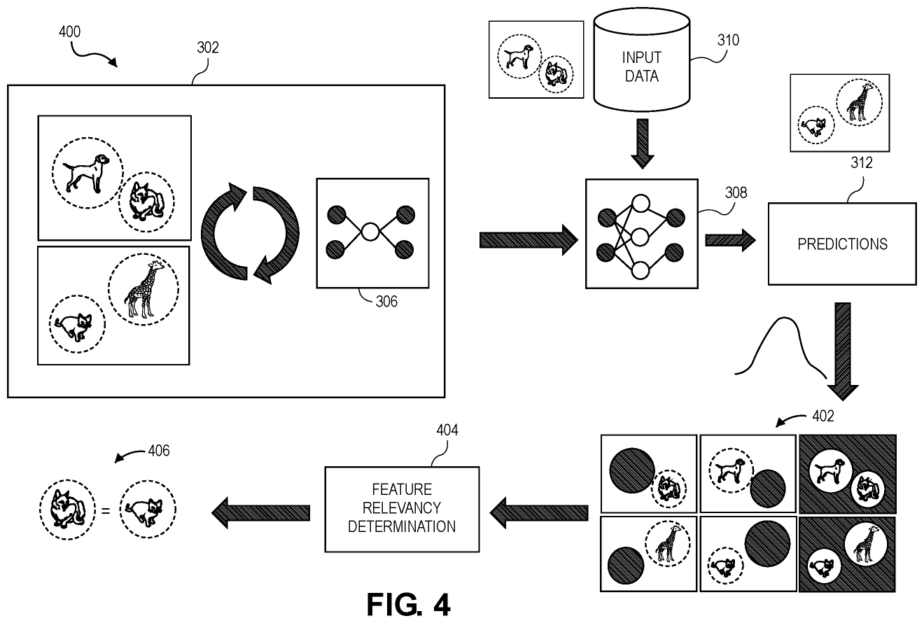

FIG. 4 depicts an exemplary system 400 for an embodiment. In some embodiments, training process 302 comprises training data 304 and initial model 306. In some embodiments, as discussed with regard to FIG. 3, training process 302 results in trained machine learning model 308 which receives input data 310 to generate predictions 312. However, unlike the example in FIG. 3, the goal of this embodiment is not to generate a model to make predictions based on inputs, but rather to determine how trained machine learning model 308 makes predictions by determining the weight of the features. For the sake of clarity, training data 304 is depicted as images of animals, such as those depicted in FIG. 2, with input data 310 corresponding to image 202 and predictions 312 corresponding to image 210. In other words, in this exemplary embodiment, trained machine learning model 308 received image 202 as an input, searched a plurality of images, and determined that image 210 was a match, that is, image 210 received a score from model 308 higher than other images in the plurality of considered images. The remainder of system 400 determines why image 210 was considered a match by looking at the features and pairwise features of image 202 and image 210 and evaluating how the machine model's output score changes when features are modified. However, embodiments of the invention can be employed regardless of the particular machine learning application. In some embodiments, trained machine learning model 308 may be received directly as a previously trained model.

Once trained machine learning model 308 generates predictions 312 based on input data 310, sample data 402 is generated to determine the weights of the features of input data 310 and predictions 312 which caused machine learning model 308 to generate predictions 312. Sample data 402 may be used to evaluate the output score of the machine learning model with some features of input data 310 and predictions 312 displaced or turned off, such as by replacing a subset of features with a neutral or background version of itself. The details of replacing a feature with a neutral value may vary based on the specific feature domain and the machine learning application. For example, in some embodiments, sample data 402 may be generated by removing text tokens or sentences, graying out parts of an image, or replacing numerical features with random values that follow the distribution from a training set, or replacing numeral features with a fixed value, such as the median or mean of the training set for a particular value. For example, a series of sample data 402 may include images wherein each superpixel of an image is grayed out in one instance of sample data 402. In further embodiments, features can be binary values that represent whether original features of input data 310 or predictions 312 are preserved or displaced or turned off, and sample data 402 can consist of these features being turned on or off, or the features as absent or present. For example, a feature that is dropped could be represented by a 0, and a feature present could be represented as a 1. In some embodiments, sample data 402 may be generated using a normalized probability distribution to minimize the amount of sample data 402 required.

In some embodiments, sample data 402 may be determined in part by specifying a distance function and a Kernel function to determine the sample neighborhood. In further embodiments, the Hamming distance may be used as a distance function. For example, the distance function may be represented as the number of features dropped/absent:

$$D ( {\vec{z}}^{′} ) = {\sum }_{i} ( 1 - {z}_{i}^{′} )$$

In further still embodiments, an exponential Kernel function may be used. For example, the exponential Kernel function may be represented as K(d)=Ae^{-λd} where A and λ are positive real numbers representing hyperparameters that may be selected based on heuristics. In some embodiments, an exponential Kernel function may be used such that the sample data is based on a normalized probability distribution, thus reducing the amount of required sample data 402. For example, a normalized distribution as a function of distance, d, may be represented as

$$P ( d ) = \frac{( \begin{matrix}N \\ d\end{matrix} ) {e}^{- λ d}}{{( 1 + {e}^{- λ} )}^{N}} .$$

Such a normalized distribution would allow for a loss function of:

$$L ( \vec{w} ) = \frac{1}{S} {\sum }_{{\vec{z}}^{′} ∼ P ( D ( {\vec{z}}^{′} ) )} {( {\vec{w}}^{T} \cdot {\vec{z}}^{′} - s ( {\vec{z}}^{′} ) )}^{2} + α {‖ w ‖}_{2}^{2}$$

Where the sampling is done according to the probability distribution P and S is the number of samples. In some embodiments, the kernel function may be a cubic function. The samples may be produced by randomly picking a distance by sampling from the discrete distribution of the probability of each distance, and then randomly removing the features associated with that distance. In some embodiments, sample data 402 may be determined using a uniform random distribution, such as turning off each feature with a 50% probability.

Using sample data 402, feature relevancy determination 404 is used to determine weight 406 for each of the features. Feature relevancy determination 404 may minimize a loss function to find the weights associated with each feature. For example, the loss function to be minimize may be:

$$L ( \vec{w} ) = {\sum }_{{\vec{z}}^{′}} K ( D ( {\vec{z}}^{′} ) ) {( {\vec{w}}^{T} \cdot {\vec{z}}^{′} - s ( {\vec{z}}^{′} ) )}^{2} + α {‖ w ‖}_{2}^{2}$$

swherein the optimal set of weights \vec{w}*=argmin_{\vec{w}}L(\vec{w}) of the linear model may be readily interpretable to provide the feature attribution and feature importance, and wherein s(\vec{z}′) represents the machine learning model's output score given the input data 310 and a particular instance \vec{z}′ of sample data 402. In some embodiments, feature relevancy determination 404 may use a modified local interpretable model-agnostic explanation approach. In further embodiments, a linear model such as K-LASSO or Ridge regression may be used. In some embodiments, weight 406 is also determined for all pairwise features. For example, the binary feature set may be extended by concatenating a set of engineered pairwise binary functions. This allows the feature interactions to be uncovered and the weights for relevant pairwise features to be determined. Thus, not only are all the individual features for each entity assigned a weight, but the pairwise features between multiple entities are also assigned a weight. For example, the loss function including pairwise binary functions may be:

$$L ( {\vec{w}}_{p a i r} ) = \frac{1}{S} {\sum }_{{\vec{z}}^{′} ∼ P ( D ( {\vec{z}}^{′} ) )} ( {\vec{w}}_{p a i r}^{T} \cdot {\vec{z}}_{pair}^{′} - {s ( {\vec{z}}^{′} ∼ P ( D ( {\vec{z}}^{′} ) ) )}^{2} + α {‖ w ‖}_{2}^{2}$$

with the difference being that the extended binary feature vector \vec{z}′ₚₐᵢᵣ is used in the ridge regression, where \vec{z}′ₚₐᵢᵣ=(\vec{z}ₐ, \vec{z}_{b}, \vec{z}ₐ ×\vec{z}_{b}). Embodiments are also contemplated for n-tuples of features for an arbitrary n, such as 3, 4, 5, or any other value up to and including the number of features in the data set.

Weight 406 for each feature and pairwise feature indicates the significance of each feature and pairwise feature. For example, in this embodiment the weight of the pair of features of animal 208 and animal 214 of FIG. 2 would indicate that image 210 was selected as a match because of the combination of these two features. In some embodiments, a higher weight indicates a more significant feature or pairwise feature. For example, in a machine learning model trained to identify a matching image based on the images containing the same animal, the pairwise features corresponding to the superpixels containing the matching animals may have the highest weight of any of the features or pairwise features, thus indicating that these pairwise features are the most significant for determining that the images match.

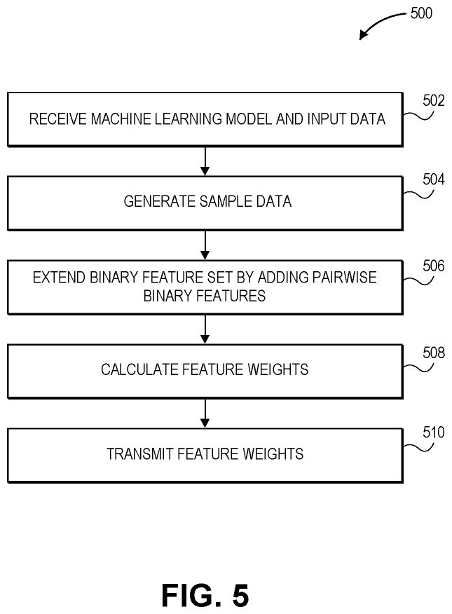

FIG. 5 depicts method 500 of an embodiment. In some embodiments, the purpose of method 500 may be to determine the weights of all features and pairwise features for input data and the prediction of a machine learning model to better understand the impact of the features and pairwise features in the predictions generated by the machine learning model. A machine learning model and input data may be received and used to generate a prediction. Sample data may be generated based on the input data and the prediction. Pairwise binary features may be generated to examine the impacts of multiple features as a pair, such as the pairs of features of the input data and the prediction. For example, feature pairs will be generated for an input image and the predicted match. A loss function using the sample data and the extended binary feature set may then be minimized to determine the weights for each feature and feature pair. In some embodiments, these weights may then be used to inform a user about the importance of each feature and feature pair. For example, the weights may allow a user to determine the specific features of the input image and the predicted match which were significant in finding a matching image.

At step 502, a machine learning model and input data is received and used to generate a prediction. The input data may be used with the machine learning model such that the machine learning model generates a prediction. In some embodiments, the machine learning model may be an information retrieval machine learning model. In some embodiments, the machine learning model may be received from a user. In other embodiments, the machine learning model may be generated based on training data. A machine learning model may take data as an input and predict an output. The input data may comprise a set of features relevant to the input data. For example, the machine learning model may be trained to find a matching image for an input image, and the input data may be an image and an image database to search. The image database to search may be located at a separate location and may be given as an identification of the location of the image database. In some embodiments, the machine learning model may be received after being trained on training data.

At step 504, samples are generated. The samples are generated using the input data and the prediction such that they may be used to determine the significance of each feature and feature pair. In some embodiments, the samples may be generated from a normalized probability distribution. Samples may be generated by creating a perturbed sample by replacing a subset of features with a neutral feature. For example, in a text search embodiment individual words may be replaced with an empty or null string. As another example, in an image search embodiment, portions of the images may be grayed out. Other types of input data may have other techniques for generating sample data appropriately, as discussed above. The sample data can be used to determine how the absence of particular features affects the predictions of the machine learning algorithm.

At step 506, a binary feature set may be extended by concatenating a set of engineered pairwise binary features. For example, a normal binary feature set for two images would include the features from a first image and the features from a second image. In some embodiments, a set of engineered pairwise binary features would include the cartesian product of the features from the first image and the features from the second image. The resulting binary feature set would include the features from the first image, the features from the second image, and the product of all of the features from the first image and the second image. Adding the pairwise binary features allows the weights to be determined for the pairwise binary features as well as the binary features, thus enabling a better understanding of a machine learning model which has feature interactions.

At step 508, the weights are calculated for each binary and pairwise binary feature. In some embodiments, the weights may be a number between zero and one. The weights may be an indication of the significance of a particular feature or feature pair to a prediction from the machine learning model. For example, the weights may simulate a linear regression model for the indicated feature. In some embodiments, the weights are calculated using the generated sample data. In further embodiments, the weights are calculated by minimizing a loss function to measure the impact of each feature and feature pair on the prediction.

At step 510, the weights are transmitted. In some embodiments, the weights may be transmitted to a user in response to the user transmitting a machine learning model. In further embodiments, a subset of the weights may be transmitted. For example, only the highest weight may be transmitted. As another example, the top five weights may be transmitted. In some embodiments, there may be a threshold and only weights above the threshold may be transmitted. In further embodiments, instead of the weights being transmitted an ordered list ranked by weights may instead be transmitted to indicate an order of feature or feature pair significance.

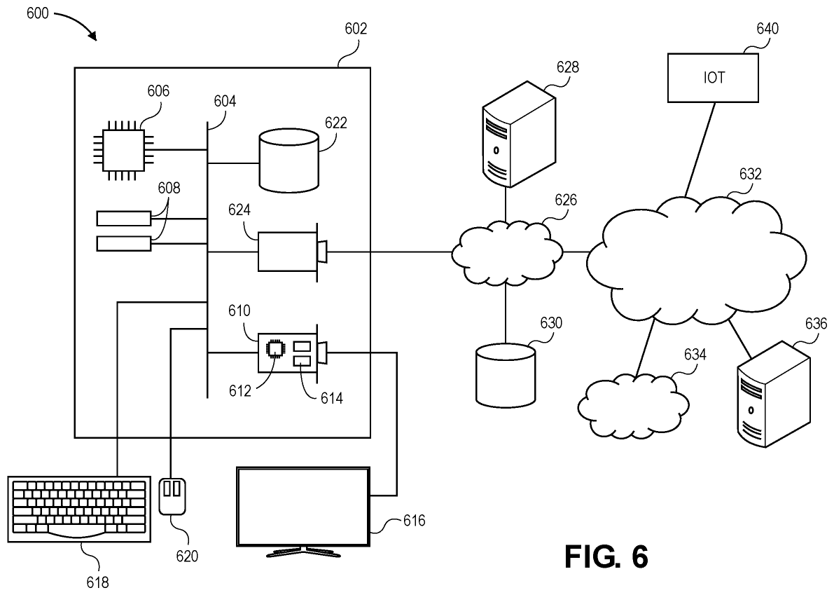

FIG. 6 depicts an exemplary hardware platform for certain embodiments. Computer 602 can be a desktop computer, a laptop computer, a server computer, a mobile device such as a smartphone or tablet, or any other form factor of general- or special-purpose computing device containing at least one processor. Depicted with computer 602 are several components, for illustrative purposes. In some embodiments, certain components may be arranged differently or absent. Additional components may also be present. Included in computer 602 is system bus 604, via which other components of computer 602 can communicate with each other. In certain embodiments, there may be multiple buses or components may communicate with each other directly. Connected to system bus 604 is central processing unit (CPU) 606. Also attached to system bus 604 are one or more random-access memory (RAM) modules 608. Also attached to system bus 604 is graphics card 610. In some embodiments, graphics card 610 may not be a physically separate card, but rather may be integrated into the motherboard or the CPU 606. In some embodiments, graphics card 610 has a separate graphics-processing unit (GPU) 612, which can be used for graphics processing or for general purpose computing (GPGPU). Also, on graphics card 610 is GPU memory 614. Connected (directly or indirectly) to graphics card 610 is display 616 for user interaction. In some embodiments no display is present, while in others it is integrated into computer 602. Similarly, peripherals such as keyboard 618 and mouse 620 are connected to system bus 604. Like display 616, these peripherals may be integrated into computer 602 or absent. Also connected to system bus 604 is local storage 622, which may be any form of computer-readable media, such as non-transitory computer readable media, and may be internally installed in computer 602 or externally and removably attached. Such non-transitory computer readable media may include transient memory such as RAM or other types of volatile computer readable media that do not persist stored information beyond a system shutdown or restart. It is understood that persistent storage (such as disk or solid state drive technology) is both non-transitory as well as non-transient, in that data stored in persistent storage persists data storage beyond a system restart.

Thus, non-transitory, computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Finally, network interface card (NIC) 624 is also attached to system bus 604 and allows computer 602 to communicate over a network such as network 626. NIC 624 can be any form of network interface known in the art, such as Ethernet, ATM, fiber, Bluetooth, or Wi-Fi (i.e., the Institute of Electrical and Electronics Engineers (IEEE) 802.11 family of standards). NIC 624 connects computer 602 to local network 626, which may also include one or more other computers, such as computer 628, and network storage, such as data store 630. Generally, a data store such as data store 630 may be any repository from which information can be stored and retrieved as needed. Examples of data stores include relational or object-oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data sets stored therein such as backup or versioning. Data stores can be local to a single computer such as computer 628, accessible on a local network such as local network 626, or remotely accessible over public Internet 632. Local network 626 is in turn connected to public Internet 632, which connects many networks such as local network 626, remote network 634 or directly attached computers such as computer 636. In some embodiments, computer 602 can itself be directly connected to public Internet 632.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “computer-readable medium” refers to any computer program product, apparatus and/or device, such as for example magnetic discs, optical disks, memory, and Programmable Logic Devices (PLDs), used to provide machine instructions and/or data to a programmable processor, including a computer-readable medium that receives machine instructions as a computer-readable signal. The term “computer-readable signal” refers to any signal used to provide machine instructions and/or data to a programmable processor. The computer -readable medium can store such machine instructions in a non-transitory manner, such as for example as would a non-transient solid-state memory or a magnetic hard drive or any equivalent storage medium. The computer-readable medium can alternatively or additionally store such machine instructions in a transient manner, for example as would a processor cache or other random-access memory associated with one or more physical processor cores.

Many different arrangements of the various components depicted, as well as components not shown, are possible without departing from the scope of the claims below. Embodiments have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims. Although the present teachings have been described with reference to the embodiments illustrated in the attached drawing figures, it is noted that equivalents may be employed and substitutions made herein without departing from the scope of the present teachings as recited in the claims.

Having thus described various embodiments, what is claimed as new and desired to be protected by Letters Patent includes the following:

1. One or more non-transitory computer-readable media storing computer-executable instructions that, when executed by at least one processor, perform a method for feature attribution in a machine learning model, the method comprising:
receiving, from a user, a machine learning model and input data;
generating a prediction using the machine learning model and the input data;
generating a plurality of samples for the machine learning model by eliminating features from the input data and the prediction;
calculating a weight for at least one feature and at least one feature pair of the input data and the prediction using the plurality of samples; and
transmitting the weight for the at least one feature and the at least one feature pair to the user.

2. The non-transitory computer-readable media of claim 1, wherein the machine learning model is an information retrieval machine learning model.

3. The non-transitory computer-readable media of claim 1, wherein the plurality of samples for the machine learning model are generated based on a normalized probability distribution.

4. The non-transitory computer-readable media of claim 1, wherein calculating the weight for one or more features and one or more feature pairs involves a local interpretable model-agnostic explanation method.

5. The non-transitory computer-readable media of claim 1, wherein generating a plurality of samples for the machine learning model uses a Hamming distance to determine the plurality of samples.

6. The non-transitory computer-readable media of claim 1, wherein the input data is an image, and the plurality of samples are generated by graying out regions of superpixels from the image.

7. The non-transitory computer-readable media of claim 1, wherein calculating the weight for the at least one feature and the at least one feature pair is done using a ridge regression.

8. A method for method for feature attribution in a machine learning model, the method comprising:
receiving, from a user, a machine learning model and input data;
generating a prediction using the machine learning model and the input data;
generating a plurality of samples for the machine learning model by eliminating features from the input data and the prediction;
calculating a weight for at least one feature and at least one feature pair of the input data and the prediction using the plurality of samples; and
transmitting the weight for the at least one feature and the at least one feature pair to the user.

9. The method of claim 8, wherein the machine learning model is an information retrieval machine learning model.

10. The method of claim 8, wherein the plurality of samples for the machine learning model are generated based on a normalized probability distribution.

11. The method of claim 8, wherein calculating the weight for one or more features and one or more feature pairs involves a local interpretable model-agnostic explanation method.

12. The method of claim 8, wherein generating a plurality of samples for the machine learning model uses a Hamming distance to determine the plurality of samples.

13. The method of claim 8, wherein the input data is an image, and the plurality of samples are generated by graying out regions of superpixels from the image.

14. The method of claim 8, wherein calculating the weight for the at least one feature and the at least one feature pair is done using a ridge regression.

15. A system for feature attribution in a machine learning model, the system comprising:
at least one processor; and
at least one non-transitory memory storing computer executable instructions that when executed by the at least one processor cause the system to carry out actions comprising:
receiving, from a user, a machine learning model and input data;
generating a prediction using the machine learning model and the input data;
generating a plurality of samples for the machine learning model by eliminating features from the input data and the prediction;
calculating a weight for at least one feature and at least one feature pair of the input data and the prediction using the plurality of samples; and
transmitting the weight for the at least one feature and the at least one feature pair to the user.

16. The system of claim 15, wherein the machine learning model is an information retrieval machine learning model.

17. The system of claim 15, wherein the plurality of samples for the machine learning model are generated based on a normalized probability distribution.

18. The system of claim 15, wherein calculating the weight for one or more features and one or more feature pairs involves a local interpretable model-agnostic explanation method.

19. The system of claim 15, wherein generating a plurality of samples for the machine learning model uses a Hamming distance to determine the plurality of samples.

20. The system of claim 15, wherein the input data is an image, and the plurality of samples are generated by graying out regions of superpixels from the image.
